(19) United States
(12) Patent Application Publication
(10) Pub. No.: US 2016/0350684 A1
(43) Pub. Date: Dec. 1, 2016

(54) WORKSITE DATA INTEGRITY AND ANALYTICS

(71) Applicant: William B. Wachtel, Chappaqua, NY (US)

(72) Inventor: William B. Wachtel, Chappaqua, NY (US)

(21) Appl. No.: 15/170,467

(22) Filed: Jun. 1, 2016

Related U.S. Application Data
(60) Provisional application No. 62/169,260, filed on Jun. 1, 2015.

(51) Int. Cl. G06Q 10/06; G06Q 40/00; G06Q 10/10

(52) U.S. Cl. CPC G06Q 10/0633; G06Q 10/1091; G06Q 40/125

(57) ABSTRACT

Methods, systems, and devices for tracking and analyzing worksite data are described. For example, a system of tracking and analyzing worksite data includes an analytics system to perform operations including: obtain access control data associated with workers accessing a worksite; obtain payroll data associated with the workers accessing the worksite; and reconcile the payroll data based on the access control data.

### CROSS REFERENCE TO RELATED APPLICATIONS

This application claims priority to U.S. Provisional Patent Application No. 62/169,260, filed on Jun. 1, 2015, entitled WORKSITE DATA INTEGRITY AND ANALYTICS, which is hereby incorporated by reference in its entirety.

### TECHNICAL FIELD

The disclosed technology relates to systems, devices, and processes that utilize data tracking and analysis technologies.

### BACKGROUND

At various worksites, such as construction sites, a large number of workers enter and exit on an hourly, daily, or weekly basis. Given such large numbers, it may be difficult to monitor and track when workers are at the construction sites, when they are working, where they are located, and so on.

### SUMMARY

Examples of the disclosed technology can provide accurate and automated tracking of time, attendance, and payroll data. The automated tracking includes daily worksite attendance, daily time sheet review, and reconciliation of payroll vs. attendance data. The disclosed technology includes systems, devices, techniques, and computer implemented program products for performing the automated worksite data tracking. In addition, the disclosed technology includes analytics to provide on-demand data analysis and statistics. Results of the on-demand data analysis and statics can be displayed to a user on-demand and in real time. Examples of data analysis and statistics include: (1) periodic (e.g., monthly, weekly, or daily) dashboard views of data reconciliation; (2) daily and weekly statistical analysis; (3) individual employee's data collection, retention and analysis; (4) anomaly detection; and other results.

Therefore, the disclosed technology provides a fully-integrated, construction risk management process and system designed to reduce owner costs and liabilities. The system enables real-time risk monitoring of industrial projects and features interactive modeling to meet stakeholder demands and expectations.

For example, the systems and methods may track, verify, reconcile, and/or manage the timely attendance of workers, in order to obtain accurate payroll data and payments, as well as to assess risks and associated insurance. Using the obtained data, the systems and methods may generate or determine a risk profile per individual or entity, which may be provided to an enterprise wide reporting and analytics system or interface.

In some embodiments, the disclosed technology provides for a system specifically designed to manage multi-faceted construction projects throughout all stages of development. The technology is fully scalable and customizable, employing real-time analytics. Among its many functions, the technology delivers: real-time enterprise-wide access control tracking; construction payroll analytics; enterprise OCIP tracking/predictive modeling; enterprise base safety, health, and environmental management systems; active monitoring of builder risk; trade contractor database/risk profiles; and/or corporate M/WBE compliance monitoring.

### BRIEF DESCRIPTION OF THE DRAWINGS

FIG. 1 is a block diagram of a suitable system for data collection and analysis.

FIGS. 2A and 2B are screenshots of worksite data, including access control data.

FIG. 3 is a screenshot of a reconciliation of daily payroll data against access control data.

FIG. 4 is a screenshot of an analysis of daily payroll data to obtain manpower performance and workforce allocation.

FIG. 5 is a screenshot of a payroll data analysis including payroll-access gap trend.

FIG. 6 is a screenshot of a reconciliation of payroll data against access control data.

FIG. 7 is a screenshot of a generated employee profile.

FIG. 8 is a flow diagram illustrating a method for tracking and analyzing worksite data.

### DETAILED DESCRIPTION

Examples of the disclosed technology provide for techniques, systems, devices, and computer program products for tracking and analyzing worksite data in real time. The disclosed technology can include automated tracking of the worksite data including daily worksite attendance, daily time sheet review, and reconciliation of payroll vs. attendance data. In addition, the disclosed technology includes analytics to provide on-demand data analysis and statistics. Results of the on-demand data analysis and statics can be displayed to a user on-demand and in real time. Examples of data analysis and statistics include: (1) periodic (e.g., monthly, weekly, or daily) dashboard views of data reconciliation; (2) daily and weekly statistical analysis; (3) individual employee's data collection, retention and analysis; and (4) anomaly detection.

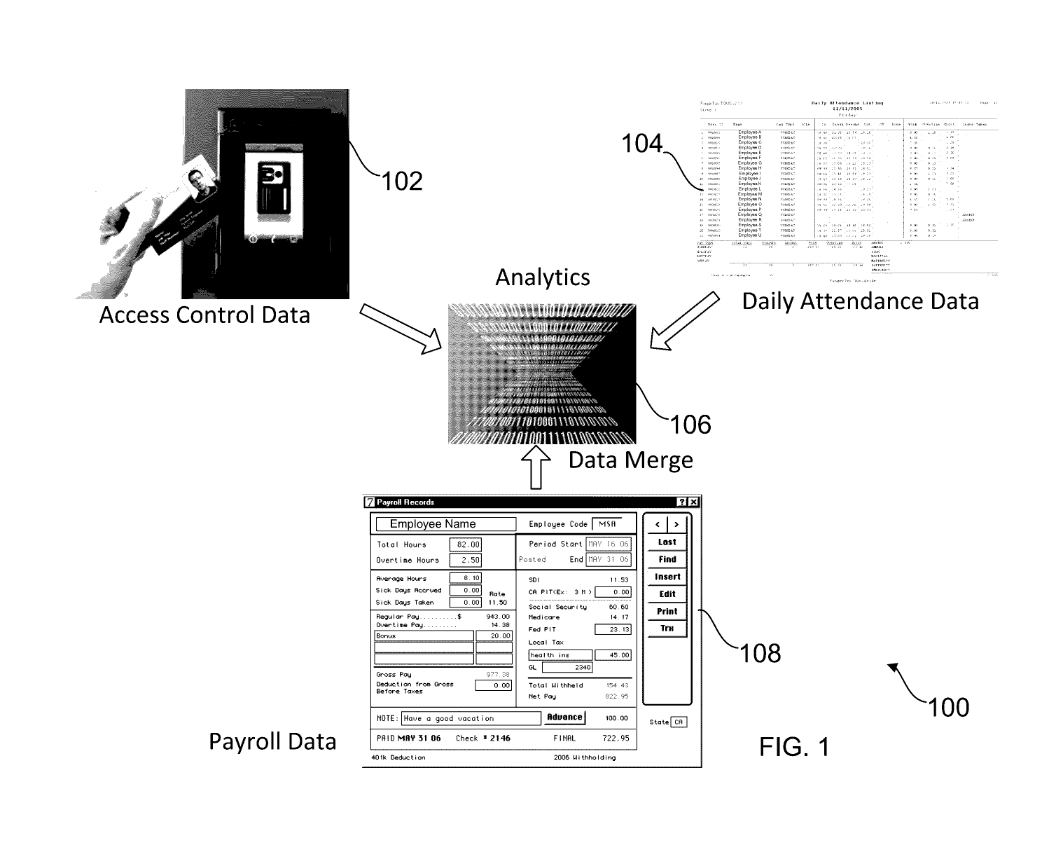

FIG. 1 is a block diagram of an exemplary system 100 for data collection and analysis. The system includes a data analytics system 106 to perform data collection, data merge, and data analysis from different data collection systems. The data analytics system 106 can be implemented using one or more server computers located at the worksite or remotely and wirelessly connected to the data collection systems. Among other computing components, a server computer includes a processor to execute computer programs. The server computers can also interface with one or more data storage systems that are locally or remotely located. The server computers and data storage systems can be in communication with each other over a secured private or public network, such as a local area network, wide area network, or the Internet. In addition, the data analytics system 106 can be in communication with a presentation system, such as one or more electronic device with a display unit for displaying the collected and analyzed data to a user. The presentation system can communicate with the data analytics system 106 wireless over the secured private or public network. Examples of the presentation system include desktop computers, laptop computers, tablet computers, smartphones, and wearable computing devices.

For example, access control system 102 can obtain access control data that provides information on the daily attendance (entry and exit) of each worker or employee into a worksite. The access control system 102 can implement various access control technologies such as an employee badge associated with a corresponding employee that controls access to the worksite. The employee badge can be equipped with a local data storage or identification unit such as a magnetic strip, near field communication (NFC) chip, radio frequency identification (RFID) tag, etc. that interfaces with an access control unit at the entry point (e.g., a locked gate) to verify the identity of the employee before allowing access to the worksite. Other access control technologies, such as biometric sensing (e.g., fingerprint detection) can be used. Also, in some implementations, the employee badge can be replaced with a mobile device, such as a smartphone or a wearable device (e.g., smart watch) that includes the employee information and interfaces with the access control unit at the entry point.

The system 100 can include a payroll system 108 that stores and maintains payroll data for all employees or workers at the worksite. The payroll data include all necessary information associated with payroll for the worksite including a list of employees, employee identification number, employer information, hours worked including overtime hours, sick days accrued, sick days taken, regular pay, overtime pay, gross pay, detection amount, taxes paid, pay period, other deductions from pay, comments, etc. The payroll data can be displayed on a display unit, such as desktop computers, laptop computers, tablet computers, smartphones, and wearable computing devices. The payroll system can include one or more server computers and one or more data storage systems for storing and maintaining the payroll data. The payroll system can be part of the employer's information technology system, a third party payroll maintenance system, or a part of the data analytics system 100.

The system 100 can include an attendance system 104 for collecting and maintaining worker attendance information, including daily attendance data. The attendance data can include a list of employees, user identification, and all information associated with the activities of the employees at the worksite on a daily basis. The activities can include time of entry and exit into the worksite, break time, hours worked, hours at break, overtime hours, leave taken, etc. The payroll data can be displayed on a display unit, such as desktop computers, laptop computers, tablet computers, smartphones, and wearable computing devices. The attendance system 104 can include one or more server computers and one or more data storage systems for storing and maintaining the attendance data. The attendance system 104 can be part of the employer's information technology system, a third party attendance maintenance system, or a part of the data analytics system 100.

The data analytics system 106 receives the different worksite data set from the access control system 102, payroll system 108, and the attendance system 104. All or some of the received worksite data are merged and analyzed by the data analytics system 106. For example, the analytics system 106 can use the access control data to update the attendance data or perform reconciliation between the access control data and the attendance data. Also, the analytics system 106 can perform reconciliation of the payroll data against the access control data. Similarly, the analytics system 106 can perform reconciliation of the payroll data against the attendance data.

FIG. 1 and the discussion herein provide a brief, general description of a suitable computing environment 100 in which the systems and methods can be supported and implemented. Although not required, aspects of the systems and methods are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

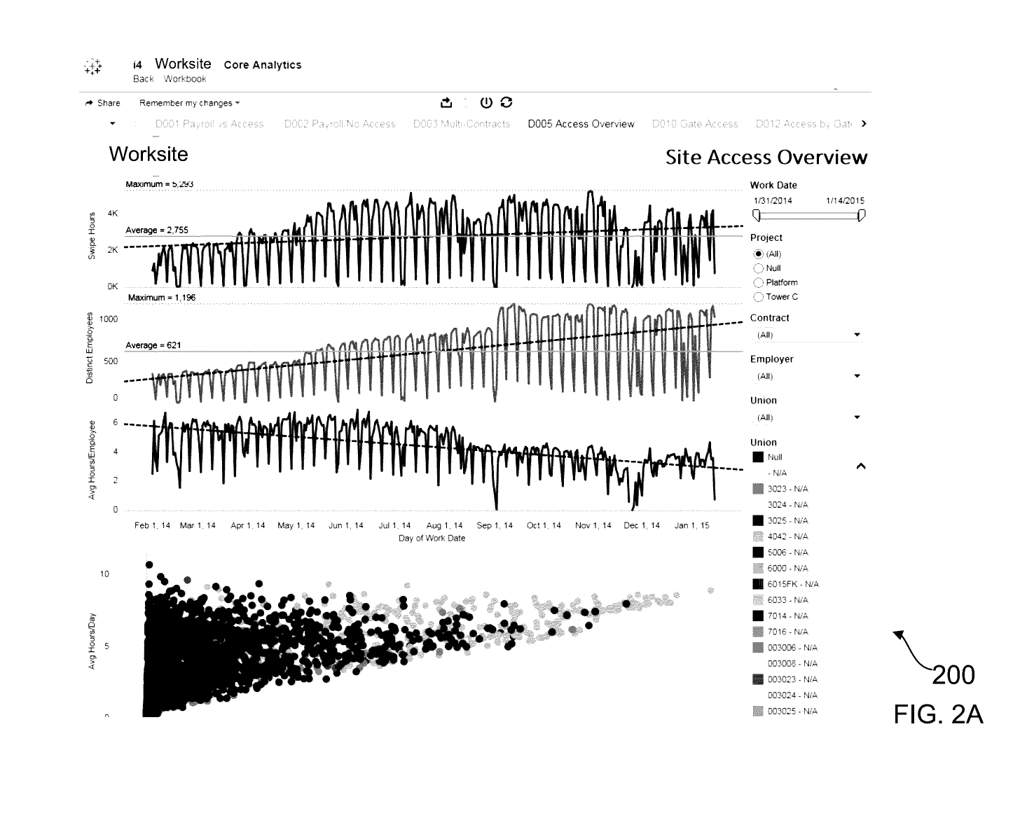

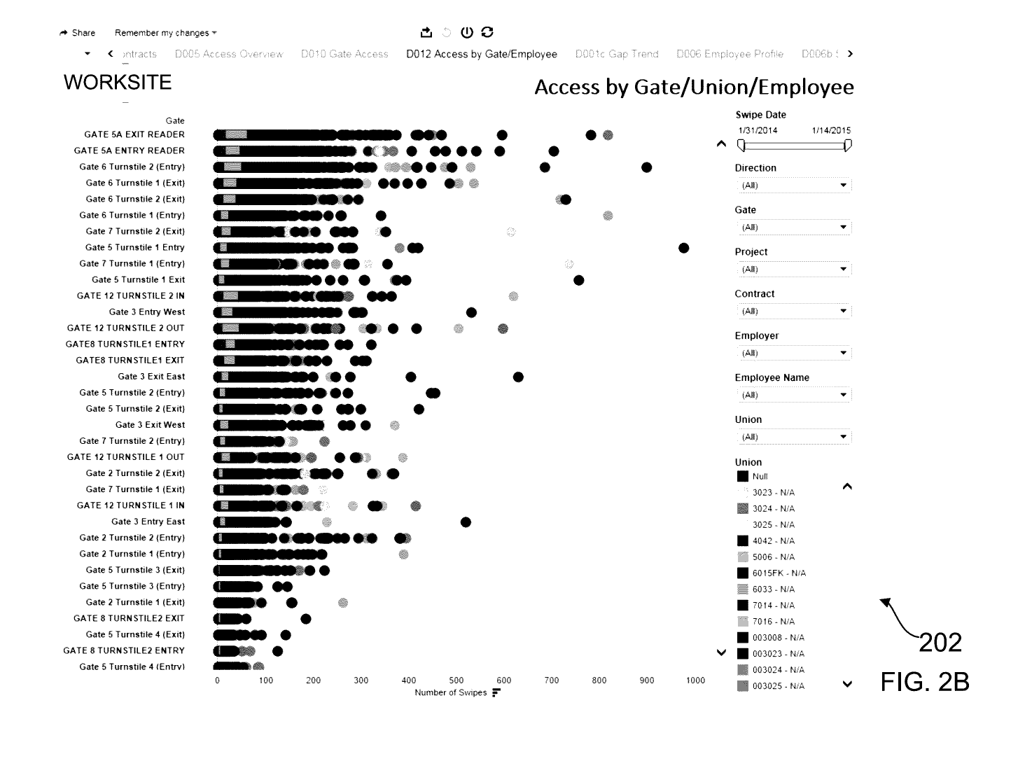

FIGS. 2A, 2B, 3, 4, 5, 6, and 7 depict various examples of data collection, tracking and analysis of the various worksite data.

For example, FIGS. 2A and 2B are screenshots 200 and 202 of exemplary worksite data, including access control data. As shown in FIG. 2A, the Site Access Overview screen shows the basic access control information regarding the worksite. The system 100 tracks and sorts worksite access data obtained from employer (e.g., employer's database) and entrance location (e.g., access control system 102). The obtained access control data is analyzed to provide an individual worksite access snapshot of all employees at the worksite. Examples of access control data that can be analyzed and displayed include: (1) the total number of hours by workers at worksite per day; (2) number and average swipe (e.g., access) hours; (3) number of distinct employees; (4) average hours per employee; and (5) average hours per day. The access control data can be sorted by individual, trade, contract, time, Union and more. Additionally, the system 100 can analyze the granular patterns of workers' access to the worksite. FIG. 2B shows access by gate, union, or employee. As shown in FIG. 2B, each gate or access point at the worksite is monitored for access by an employee.

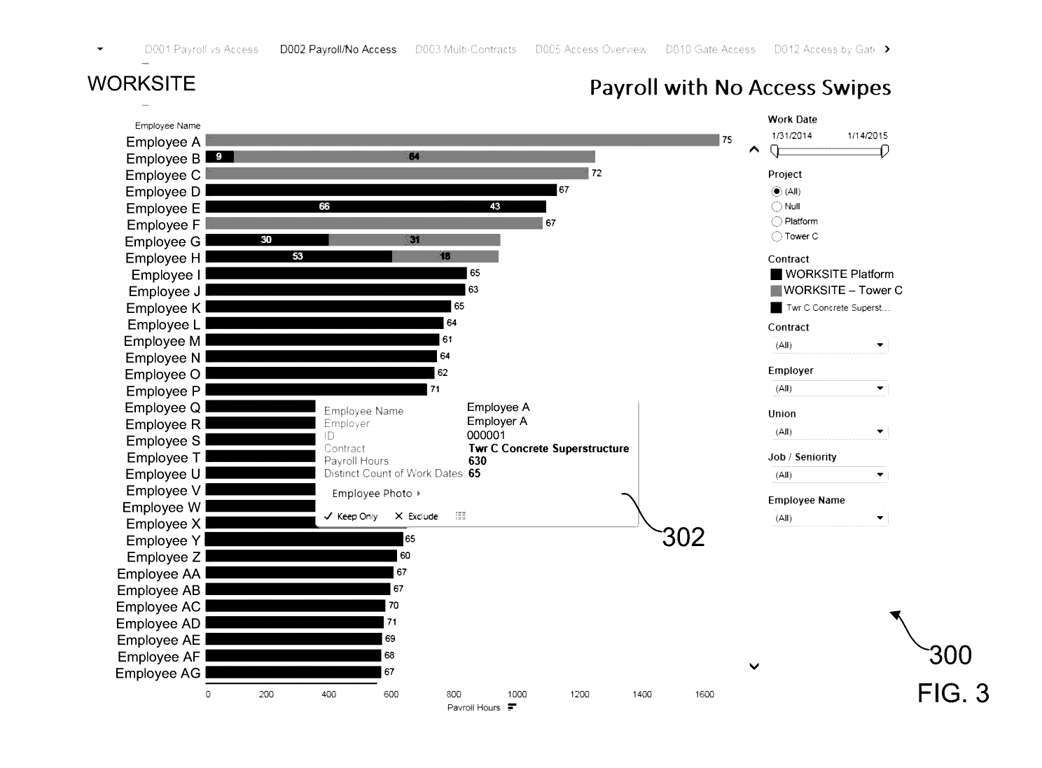

FIG. 3 is a screenshot 300 of an exemplary reconciliation of daily payroll data against access control data. The screenshot 300 shows the Payroll vs. Access Control reconciliation. Daily payroll data is reconciled against access control to provide quick view on workforce payroll verification. Shown in screenshot 300, individuals are identified as receiving payroll without site access (attendance) verification. This identifies issues with compliance, worksite security and quickly identifies issues with fraud (Ghost employees). Sorting function can be modified by employer, employee, trade and more. Individual employee data can be highlighted and displayed using a separate or pop-up window 302.

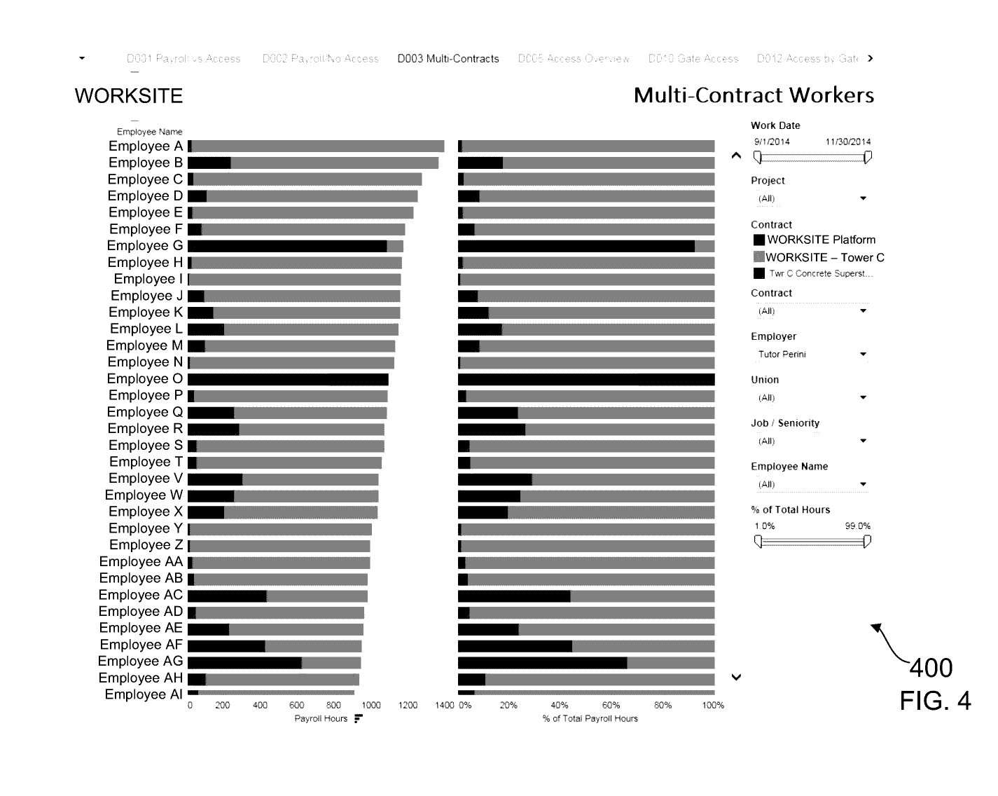

FIG. 4 is a screenshot 400 of an exemplary analysis of daily payroll data to obtain manpower performance and workforce allocation. Screenshot 400 shows the Payroll Multi Contract data. Daily payroll data is analyzed to identify workers who are being paid under multiple contracts within the same project, i.e. where multiple buildings may be being constructed within the perimeter of a single development project. This aids in the review of manpower performance and workforce allocation.

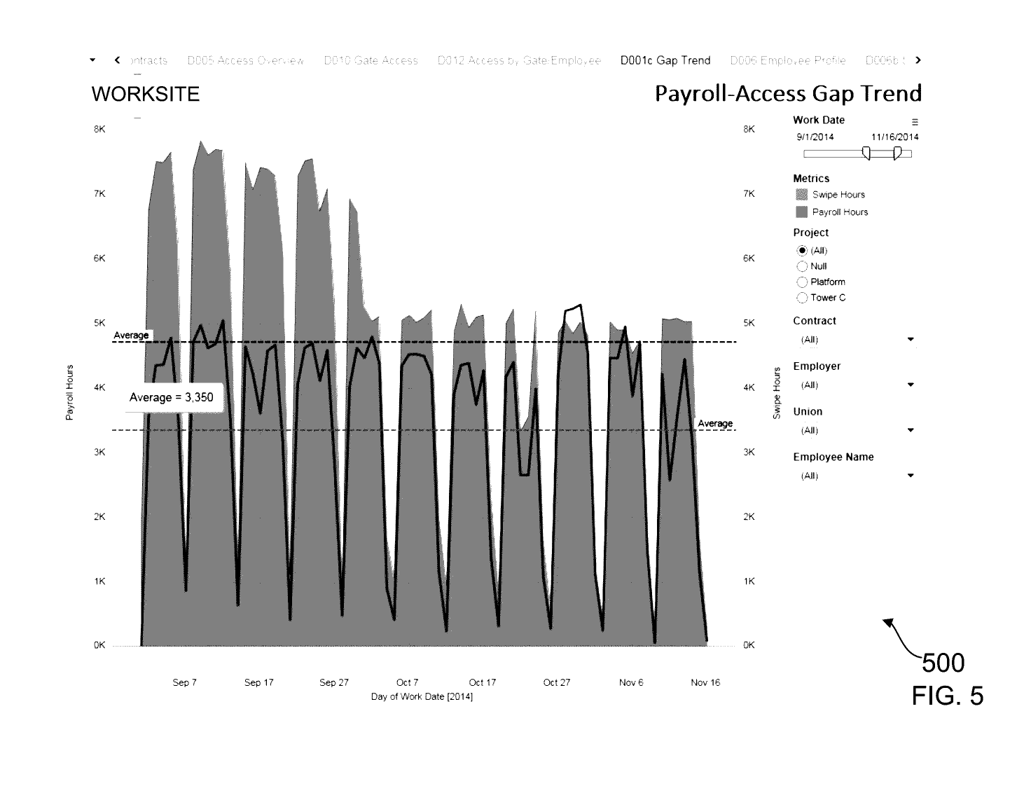

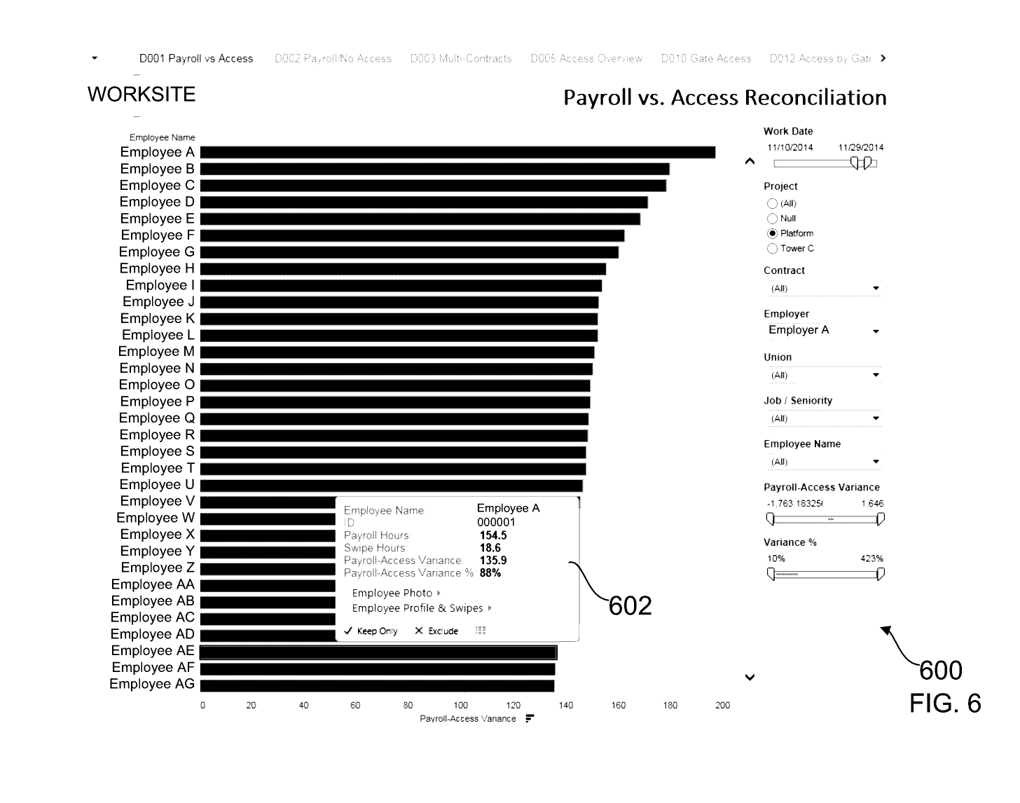

FIG. 5 is a screenshot 500 of an exemplary payroll data analysis including payroll-access gap trend. FIG. 6 is a screenshot 600 of an exemplary reconciliation of payroll data against access control data. Payroll Reconciliation as shown in screenshot 600 uses data from the worksite access control system 102 (e.g., badging) and cross matches with disparate payroll data from the construction manager (e.g., payroll system 104). The disparity of payroll vs. badging swipe data has shown that additional measures need to be implemented regarding access control compliance to the site. Once compliance with the swipe data is enforced, reliable time vs payroll data can be utilized as part of a monetary loss detection program and risk profiling of an individual or an entity. Individual employee data can be highlighted and displayed using a separate or pop-up window 602.

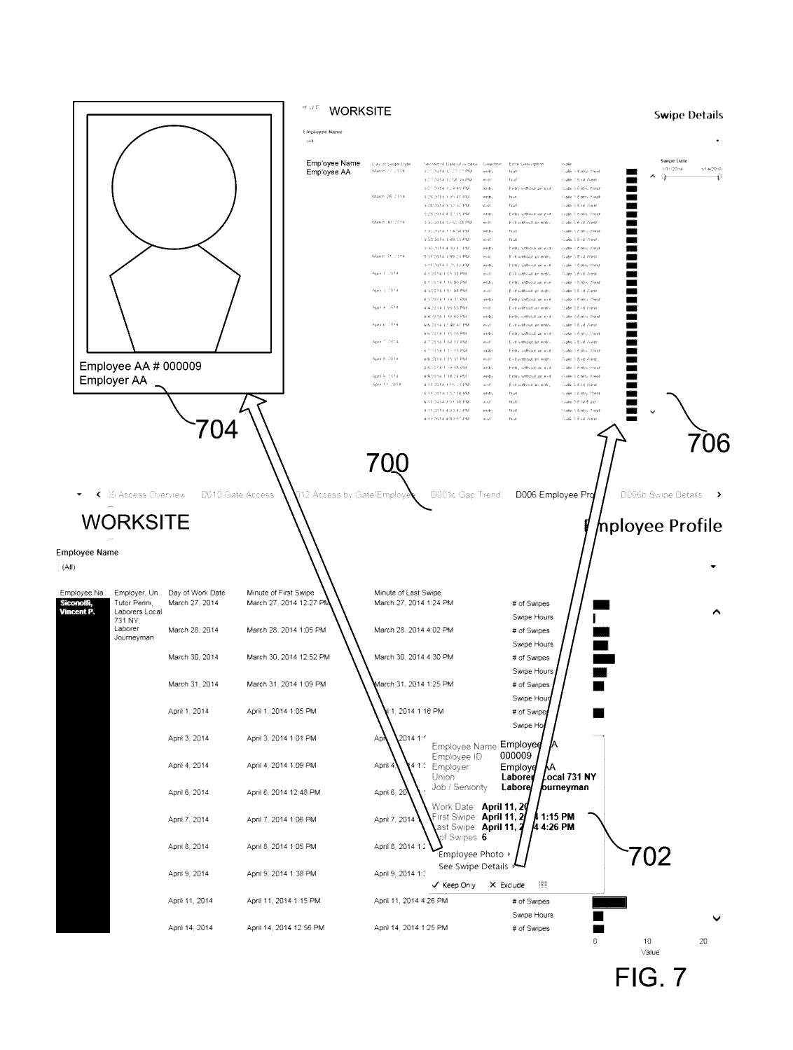

FIG. 7 is a screenshot 700 of an employee profile, such as an employee profile generated by the methods and systems described herein. The Employee Profile includes all data tied back to the employee. A record is kept of all access and payroll related to their activity 706 (e.g., swipe details) at the worksite. This aids with fraud prevention and security access. Additionally, the photo 704 of the employee can be used to cross match with security videos to verify employees' access to the site.

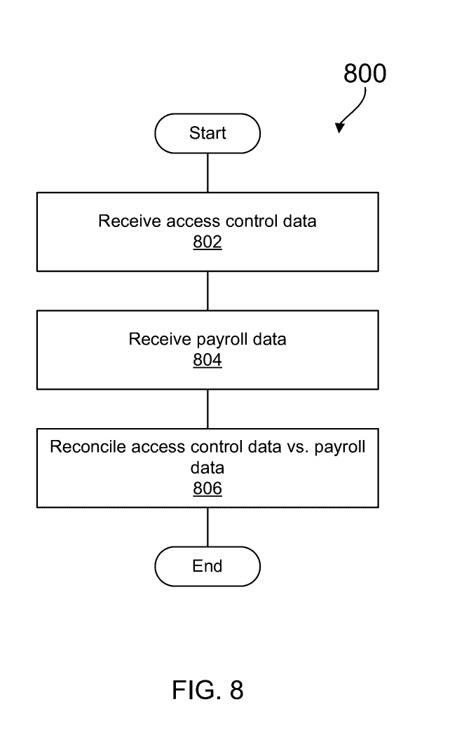

FIG. 8 is a flow diagram illustrating a method 800 for tracking and analyzing worksite data. The method 800 may be performed by the system 100 and, accordingly, is described herein merely by way of reference thereto. It will be appreciated that the method 800 may be performed on any suitable hardware.

In operation 802, the system 100 obtains access control data associated with workers accessing a worksite. For example, the access control system 102 obtains, captures, or measures access control data that provides information on the daily attendance (entry and exit) of each worker or employee into a worksite. The access control system 102 can implement various access control technologies, such as an employee badge associated with a corresponding employee that controls access to the worksite. The employee badge can be equipped with a local data storage or identification unit such as a magnetic strip, near field communication (NFC) chip, radio frequency identification (RFID) tag, etc. that interfaces with an access control unit at the entry point (e.g., a locked gate) to verify the identity of the employee before allowing access to the worksite. Other access control technologies, such as biometric sensing (e.g., fingerprint detection) can be used. Also, in some implementations, the employee badge can be replaced with a mobile device, such as a smartphone or a wearable device (e.g., smart watch) that includes the employee information and interfaces with the access control unit at the entry point.

In operation 804, the system 100 obtains payroll data associated with the workers accessing the worksite and/or attendance data associated with the workers attending the worksite. For example, the payroll system 108 includes information associated with payroll for the worksite including a list of employees, employee identification number, employer information, hours worked including overtime hours, sick days accrued, sick days taken, regular pay, overtime pay, gross pay, detection amount, taxes paid, pay period, other deductions from pay, comments, etc.

In operation 806, the system 100 reconciles the payroll data based on the access control data. For example, the data analytics system 106 receives the different worksite data set from the access control system 102, payroll system 108, and the attendance system 104, and performs comparisons of the different data sets. The analytics system 106 can use the access control data to modify and/or update the attendance data or perform reconciliation between the access control data and the attendance data. Also, the analytics system 106 can perform reconciliation of the payroll data against the access control data. Similarly, the analytics system 106 can perform reconciliation of the payroll data against the attendance data.

Therefore, the analytics system 106, in some embodiments, utilizes data captured from physical interactions with workers (via swiped badges or mobile devices proximate to entry points) to reconcile or otherwise augment the data associated with their employment (e.g., attendance and/or payroll data).

The analytics system 106 may perform various actions in response to reconciling attendance data with respect to access control data, and vice versa. These actions include updating daily worksite attendance based on the access control data, generating a periodic dashboard view of resulting data based on the reconciliation, performing periodic statistical analysis on worker attendance, performing anomaly detection based on the reconciliation, performing fraud analysis based on the reconciliation, such as identifying a ghost employee receiving payroll, identifying employees being paid under multiple contracts, identifying employees being paid without corresponding access control data (e.g., point of entry badge swipes), cross matching a photo of an employee against security video data to verify employee access to the worksite, and so on.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively or additionally, network elements performing those functions could be replaced by two or more elements to perform portions of those functions. In addition, while processes, message/data flows, or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the technology can be modified, if necessary, to employ the systems, functions, and concepts of the various references described above to provide yet further embodiments of the technology.

These and other changes can be made to the invention in light of the above Detailed Description. While the above description describes certain embodiments of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the technology.

We claim:

1. A system for tracking and analyzing worksite data, the system comprising:
an access control system that collects access control data associated with workers accessing a worksite;
an attendance system that collects attendance data associated with the workers accessing the worksite;
a payroll system that maintains payroll data associated with paying workers accessing the worksite; and
an analytics system that:
obtains the access control data associated with the workers accessing the worksite, the attendance data associated with the workers accessing the worksite, and the payroll data associated with paying workers accessing the worksite; and
reconciles the access control data, the attendance data, or the payroll data.

2. The system of claim 1, wherein the analytics system reconciles the payroll data using the access control data.

3. The system of claim 1, wherein the analytics system reconciles the payroll data using the attendance data and the access control data.

4. The system of claim 1, wherein the analytics system reconciles the attendance data using the access control data.

5. The system of claim 1, wherein the analytics system generates a periodic dashboard view of resulting data based on the reconciliation.

6. The system of claim 1, wherein the analytics system performs periodic statistical analysis on worker attendance based on the reconciliation.

7. The system of claim 1, wherein the analytics system performs anomaly detection of worker attendance data based on the reconciliation.

8. The system of claim 1, wherein the analytics system performs fraud analysis of worker attendance data based on the reconciliation.

9. The system of claim 1, wherein the analytics system identifies ghost employees receiving payroll based on the reconciliation.

10. The system of claim 1, wherein the analytics system identifies employees being paid without corresponding access control data by cross matching a photo of an employee against security video data to verify employee access to the worksite.

11. The system of claim 1, wherein the analytics system updates daily worksite attendance data with the access control data.

12. A method, comprising:
receiving attendance data associated with workers of a worksite; and
reconciling the attendance data with control access data collected from control access devices placed at the worksite.

13. The method of claim 12, wherein the control access data is collected by a device at an entry point of the worksite that determines badges associated with workers of the worksite have been proximate to the device at the entry point.

14. The method of claim 12, wherein the control access data is collected by a device at an entry point of the worksite that determines mobile devices associated with workers of the worksite have been proximate to the device at the entry point.

15. The method of claim 12, wherein reconciling the attendance data with control access data collected from control access devices placed at the worksite includes performing anomaly detection of worker attendance based on the reconciliation.

16. The method of claim 12, wherein reconciling the attendance data with control access data collected from control access devices placed at the worksite includes performing fraud analysis of worker attendance based on the reconciliation.

17. The method of claim 12, wherein reconciling the attendance data with control access data collected from control access devices placed at the worksite includes identifying ghost employees receiving payroll based on the reconciliation.

18. The method of claim 12, wherein reconciling the attendance data with control access data collected from control access devices placed at the worksite includes identifying employees being paid without corresponding access control data by cross matching a photo of an employee against security video data to verify employee access to the worksite.

19. A computer-readable storage medium whose contents, when executed by a computing system, cause the computing system to perform operations, the operations comprising:
collecting access control data associated with workers accessing a worksite;
collecting attendance data associated with the workers accessing the worksite;
maintaining payroll data associated with paying workers accessing the worksite;
obtaining the access control data associated with the workers accessing the worksite, the attendance data associated with the workers accessing the worksite, and the payroll data associated with paying workers accessing the worksite; and
reconciling the access control data, the attendance data, or the payroll data.

20. The computer-readable storage medium of claim 19, further comprising:
reconciling the payroll data using the access control data;
reconciling the payroll data using the attendance data and the access control data; and
reconciling the attendance data using the access control data.
